(19) United States
(12) Patent Application Publication
(10) Pub. No.: US 2026/0184828 A1
(43) Pub. Date: Jul. 2, 2026

(54) CYANATE ESTERS AS MONOMERS IN POLYMERIZABLE COMPOSITIONS

(71) Applicant: Technische Universität Wien, Wien (AT)

(72) Inventors: Robert LISKA, Schleinbach (AT); Raffael Johannes Bodo WOLFF, Tubling (AT); Patrick KNAACK, Wien (AT); Jürgen STAMPFL, Wien (AT)

(21) Appl. No.: 18/877,677

(22) PCT Filed: Jun. 16, 2023
(86) PCT No.: PCT/EP2023/066314

§ 371 Date: Dec. 20, 2024

(30) Foreign Application Priority Data
Jun. 23, 2022 (AT) A 60091/2022
Aug. 18, 2022 (AT) A 165/2022

(51) Int. Cl. C08F 120/34; B29C 64/124; B29C 64/314; B29K 67/00; B29K 105/00; B33Y 10/00; B33Y 40/10; B33Y 40/20; B33Y 70/00

(52) U.S. Cl. CPC C08F 120/34; B29C 64/314; B33Y 40/10; B33Y 40/20; B33Y 70/00; B29C 64/124; B29K 2067/00; B29K 2105/0002; B29K 2105/0014; B33Y 10/00

(57) ABSTRACT

Cyanate esters are used as monomers in a polymerizable composition for preparing solid articles. In particular:
a) multifunctional cyanate esters with formula R(OCN)ₙ are used as the monomers, R is an n-valent carbohydrate residue having up to 50 carbon atoms and n is an integer ≥2;
b) an organometallic photoinitiator activatable by electromagnetic radiation and/or thermal energy is used as the polymerization initiator;
c) a compound containing at least on acidic hydrogen atom is used as a co-catalyst; and
d) the polymerization is conducted in a 3D printing method which involves heating and irradiating the photopolymerizable composition.

All components of the composition are initially heated to a temperature of >70° C. to obtain a homogeneous liquid mixture, which is irradiated at least at the same temperature with a wavelength suitable to activate the organometallic polymerization initiator and obtain a three-dimensional solid body.

The present invention relates to cyanate esters as monomers in polymerizable compositions.

### STATE OF THE ART

Polycyanate esters are a relatively new class of high-performance thermosets. In general, those having at least two cyanate ester groups are used as monomers, sometimes also in the form of oligomers. Repeated cyclotrimerization leads, via tri-azine rings, i.e., cyanurate moieties, to crosslinked polymers.

Monomers include aliphatic as well as aromatic cyanate esters, the latter being preferred with regard to the thermomechanical properties of the polymers such as glass temperature, resistance, and dimensional stability. Common aromatic cyanate esters are, for example, cyanates of various benzene, biphenyl, or naphthalene derivatives, including dicyanates of bisphenols, mono- or polysubstituted with hydroxy, as well as novolak polycyanates; see, e.g., M. R. Kessler, Wiley Encyclopedia of Composites, John Wiley & Sons, Inc., Hoboken, NJ, USA, p. 1-15 (2012).

Cyclotrimerization reactions can be initiated by heating to high temperatures of, e.g., 170-200° C. or by the presence of different catalysts and optionally co-catalysts. Suitable therefor are, for example, compounds comprising acidic hydrogen atoms and those comprising bivalent transition metal ions, such as Cu²⁺, Zn²⁺, Mn²⁺, Co²⁺, or Ni²⁺, the presence of which causes the creation of complexes of three cyanate ester moieties each as ligands around the cationic central ion. This complex formation can be promoted by heating or also by the presence of acidic hydrogen atoms, as schematically shown in Scheme A on the following page for a dicyanate ester N≡C—O—R—O—C≡N as monomer, wherein —R—O—C≡N is a simplified representation of the monomer and R′OH represents the hydrogen donor:

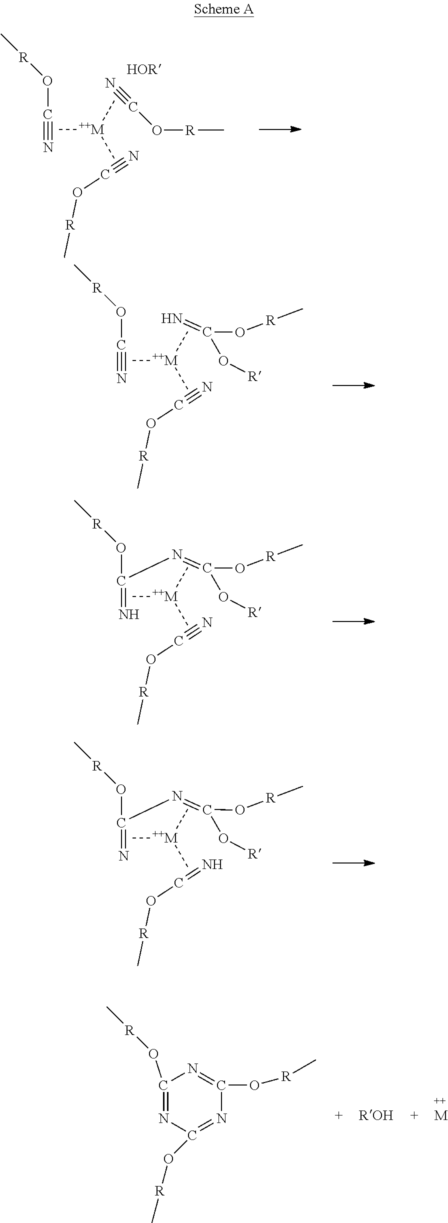

Kotch et al., Chem. Mater. 7, 801-805 (1995), also examined photopolymerizations of cyanate esters using photosensitive transition metal complexes of the formula [CpFe(η6-arene)]X, namely of (η6-toluene or-naphthalene)(η5-cyclopentadienyl)-iron(II) hexafluorophosphate or antimonate and compared them with the results obtained by using zinc octoate (zinc 2-ethylhexanoate) as thermal transition metal catalyst in the polymerization of bisphenol A and E dicyanate monomers. Here, corresponding polymerizable compositions were applied to a substrate as films and pre-cured for 15 min by heating to 383 K (120° C.) to obtain dry films. These were then irradiated with UV light with a wavelength corresponding to the Photoinitiator and finally cured at 423 K (150° C.). Due to the exposure of the pre-cured composition taking place in the meantime, the time until the beginning of the exothermic maximum of thermal curing could be reduced substantially, and the start temperature could be greatly reduced. While without any catalyst, the maximum occurred as late as at 267° C., the use of the photoinitiators reduced the temperature to 111-138° C. However, when using zinc octoate as the sole thermal catalyst, it was only 143° C.

EP 0,364,073 A1 discloses compositions based on mono- or polyvalent cyanate esters curable thermally or by irradiation by using organometallic compounds as catalysts, which are used for producing molded articles, coatings, or photoresists. The organometallic compounds described also comprise a number of photosensitive transition metal complexes that were used as catalysts. Cyanate esters used includ-ed 2,2-bis(4-cyanatophenyl)propane (bisphenol A dicyanate) and 1,1′-bis(cyanato)-biphenyl (which probably refers to the dicyanate of biphenyl-4,4′-diol). First, DSC (“differential scanning calorimetry”) and DPC (“differential photocalorimetry”) tests were conducted with powder mixtures of the corresponding transition metal complexes and cyanate esters by heating to 400° C. and irradiation with a 200 W mercury vapor lamp (in DPC) and examining the temperatures of the exotherms caused by the polymerization, where the DPC experiments showed that the polymerization of the cyanate ester started in most cases at a somewhat lower temperature, even without catalyst. The presence of the catalysts, however, caused a temperature reduction of up to 200° C. in DSC and up to 190° C. in DPC, i.e., to below 100° C. Con-sequently, mixtures of cyanate ester, Photoinitiator and optionally a solvent were then exposed to temperatures between 85° C. and 120° C., resulting in solid bodies with and without irradiation. However, their properties are not mentioned.

And WO 2017/040883 A1 discloses a method for producing three-dimensional bodies by means of a generative manufacturing process in which two-step curing of a polymerizable composition comprising a mono- or polyvalent cyanate ester is used. For this purpose, various photopolymerizable monomers or pre-polymers, such as (meth)acrylates and (meth)acrylamides as well as different vinyl and other olefinically unsaturated compounds, are first photopolymerized layer by layer at room temperature to obtain a pre-cured body, which is then exposed to thermal curing by stepwise heating to at least 200° C. and up to 300° C., so that the cyanate esters are also poly-merized. This polymerization can be promoted by the optional addition of nucleophilic co-catalysts comprising acidic hydrogen atoms and/or bivalent transition metal ions, and the initial photopolymerization is preferably conducted via Continuous Liquid Interface Production (CLIP). Here, the use of bisphenol E dicyanate polymers mainly resulted in copolymers with different acrylate comonomers with glass temperatures above 200° C.

Against this background, it was the objective of the invention to develop a method for producing three-dimensional bodies of cyanate ester monomers via a generative manufacturing method by means of which polymers with good thermomechanical properties can be obtained without the necessity of energy-intensive thermal post-treatments.

### SUMMARY OF THE INVENTION

The present invention achieves this objective by providing the use of cyanate esters as monomers in a polymerizable composition for preparing solid articles, wherein the composition additionally comprises at least one organometallic compound activatable by electromagnetic radiation and/or thermal energy as a polymerization initiator and is heated during polymerization to a temperature of >70° C.; characterized in that
a) multifunctional cyanate esters of the formula R(OCN)ₙ are used as said monomers, wherein R is an n-valent carbohydrate residue having up to 50 carbon atoms and n is an integer >2;
b) an organometallic photoinitiator is used as said polymerization initiator;
c) a compound comprising at least one acidic hydrogen atom is used as a co-catalyst; and
d) the polymerization is conducted in the course of a 3D printing method comprising heating and irradiating the photopolymerizable composition,
   wherein all components of the composition are initially heated to a temperature of >70° C. in order to obtain a homogeneous liquid mixture, which is then irradiated at at least the same temperature with a wavelength suitable to activate the organometallic compound serving as said polymerization initiator in order to obtain a three-dimensional solid body.

With the inventive combination of the characteristics a) to d) of the method, the inventors have thus succeeded for the first time in producing polymers that show excellent thermomechanical properties even without cumbersome thermal post-treat-ment from multifunctional cyanate ester monomers by means of a 3D printing method known as hot lithography, which comprises initial heating of the polymerizable composition to temperatures above 70° C. and then irradiating the liquid mixture to initiate photopolymerization, as is demonstrated by the examples below.

Here, not only the use of the approach known as hot lithography according to characteristied) on the multifunctional cyanate ester monomers according to characteristic a) is essential, but also the presence of suitable organometallic photoinitiators according to characteristied) and of the co-catalysts with acidic hydrogen atoms according to characteristic c). As will be shown by the comparative examples below, these co-catalysts are indispensable for the inventive method because the same method without co-catalysts would not result in solid polymers.

In preferred embodiments of the invention, a) multifunctional aromatic cyanate esters, in particular cyanates of bisphenol or novolak derivatives, in the form of monomers are used as multifunctional cyanate esters because they lead to better thermomechanical properties compared to aliphatic cyanate esters. In further preferred embodiments of the inventive method, multifunctional cyanate ester monomers of the formula R(OCN)ₙ are used, wherein R has not more than 40 carbon atoms and/or wherein n=2 to 4, in order to obtain, within a short time, a higher monomer turnover as well as higher crosslinking densities than would be possible using bulky or longer-chain monomer units.

During the 3D printing method d), the composition according to the present invention is furthermore preferably initially heated to a temperature of 80° C. to 100° C., more preferably 80° C. to 90° C., before irradiation and/or preferably heated to a temperature of 80° C. to 120° C., more preferably 90° C. to 100° C., during irradiation. Of course, the optimal temperatures also depend on the cyanate ester monomers used in each case and their melting points because preferred embodiments of the invention use monomers and often also photoinitiators which are solid at room temperature, the melting points of the organometallic photoinitiators sometimes being substantially higher than those of the monomers. The reaction temperatures are thus preferably selected so that, before as well as during the first irradiation phase, a liquid polymerizable composition having a suitable viscosity (typically below 20 Pa·s) is provided in order to achieve the highest possible monomer turnovers, polymerization degrees and crosslinking densities within a short time without having to add solvents, diluents or the like.

The selection of the irradiation durations for curing the individual layers depends, on the one hand, largely from the layer thickness, and on the other hand on all of the above factors, in particular on the viscosity of the homogeneous solution at the beginning of irradiation, but also on the efficiency of the respective photoinitiator, which in turn depends on the degree of light transmittance of the liquid solution. For curing compositions that are not 100% transparent, e.g., those containing fillers or colored components or those in which not all components are fully dissolved, the layer thickness may thus be reduced correspondingly in order to still achieve the most complete curing possible of the composition of the respective layer within a relatively short time.

The organometallic photoinitiator b) is not particularly limited as long as irradiation with an appropriate wavelength exposes its cationic central ion that thus becomes accessible for the attachment of the cyanate ester moieties as ligands in order to allow their trimerization. In preferred embodiments of the invention, an organometallic complex of an Al, Fe, Mn, Ru, Zn, Co, or Cu ion, more preferably an Fe ion, more preferably a sandwich or semi-sandwich compound, in particular a sandwich compound or a semi-sandwich carbonyl complex, of these metal ions is used since such photoinitiators have already proven suitable for the catalysis of cyanate ester polymerization.

For example, all organometallic initiators according to the disclosure of EP 0.364.073 A1 cited at the beginning may be used, which are activatable by irradiation with suitable wavelengths and not only thermally. These include those of the formula [CpFe(η6-arene)]X (“Kotch et al.”; above), i.e., cyclopentadienyl-arene-iron(II) complexes, also cited at the beginning, as well as similar complexes with other bivalent central ions, but also various metal carbonyl complexes. In the examples below, several examples of such organometallic photoinitiators have been used.

The co-catalyst c) used according to the present invention is not particularly limited, either, as long as it is capable of releasing at least one acidic hydrogen atom under the corresponding reaction conditions, which promotes trimerization catalyzed by the transition metal ion of the photoinitiator via protonation of one of the three cyanate ester moieties according to Scheme A above. Of course, a wide range of compounds having acidic hydrogen atoms are suitable for this purpose, such as phenols, bisphenols, alcohols, imidazoles, or aromatic amines. Due to its structure similar to the aromatic cyanate esters used as monomers according to the present invention, a phenol derivative is used as co-catalyst in preferred embodiments of the invention, more preferably nonylphenol or bisphenol A. As shown in the examples below, the presence of a co-catalyst c) is an essential characteristic for the practicability of the method of the present invention.

In preferred embodiments of the invention, an oxidizing agent is additionally mixed into the polymerizable composition in step d). According to the present invention, it is not particularly limited, however, with regard to its miscibility with the other components of the composition, an organic oxidizing agent is particularly preferred, and with regard to its availability, di-tert-butyl peroxide is most preferred. Due to the presence of the oxidizing agent, the time to reach the maximum reaction enthalpy (tₘₐₓ) and thus the polymerization process in the individual layers can be significantly shorten-ed. While not wishing to be bound by theory, the inventors assume that due to the oxidizing agent, the metal ions of the photoinitiator in the polymerizable composition can be oxidized to their highest oxidation level, e.g., from −II to −III, in which they usually show higher activity for complex formation reactions with the three cyanate ester moieties as ligands.

Further, optional, components of the polymerizable composition are also not particularly limited as long as their presence does not significantly obstruct photopolymerization of the cyanate esters and does not prevent polymers showing the desired thermomechanical properties to be obtained. Non-limiting examples of such further components are co-monomers participating in the photopolymerization of the cyanate esters while forming corresponding copolymers, such as polyvalent epoxides and maleimides, where one epoxide or maleimide group each reacts with one (epoxide) or two (maleimide) cyanate moieties. The examples below also include several using a representative co-monomer. In addition, however, suitable amounts of fillers, coloring agents or dyes, stabilizers, and other common additives may also be mixed with the polymerizable compositions.

All of the polymers obtained according to the present invention showed good thermomechanical properties.

### EXAMPLES

Below, the invention is described in further detail by means of non-limiting examples serving only to illustrate the invention, in which the following components were used.

### Characteristic a): Cyanate Ester Monomers

The following compounds were used as representative aromatic cyanate esters:
a1) a novolak cyanate (from Lonza, Primaset® PT-30) according to the following formula:

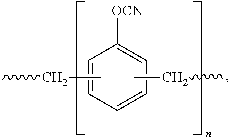

wherein n=2-3, melting point: approx. 40° C.; and
a2) bisphenol A dicyanate (2,2-bis(4-cyanatophenyl)propane; from TCI) according to the following formula:

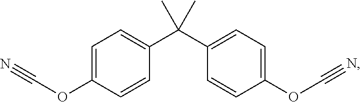 [SMILES: CC(C)(c1ccc(OC#N)cc1)c1ccc(OC#N)cc1]

melting point: 78-83° C.

In one of the inventive examples, a combination of the two cyanate esters a1) and a2) was used.

### Characteristic b): Photoinitiators

The following compounds were used as representative organometallic photoinitiators:
b1) (cumene)(cyclopentadienyl)iron(II) hexafluorophosphate, [CpFeCumol]PF₆⁻

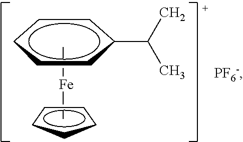

melting point: 85-87° C.;
b2) (methylcyclopentadienyl)manganese(II) tricarbonyl, Me-CpMn(CO)₃

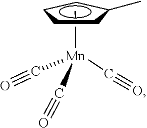

liquid at room temperature (melting point: 2,2° C.); and
b3) dicyclopentadienyl-bis[2,6-difluoro-3-(1-pyrrolyl)phenyl]titanium (bis(2,6-difluoro-3-(1-hydropyrrole-1-yl)phenyl)titanocene), Cp₂Ti(F₂Pyr)benzene

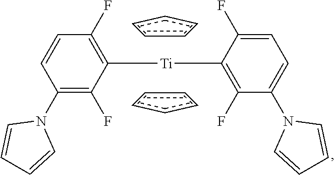

melting point: 160-170° C.

### Characteristic c): Co-Catalysts

The following compounds were used as representative co-catalysts comprising acidic hydrogen atoms:
c1) nonylphenol

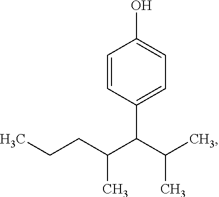 [SMILES: CCCC(C)C(c1ccc(O)cc1)C(C)C]

liquid at room temperature (melting point: −8° C.);
c2) 1,1,1-trimethylolpropane

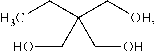

melting point: 60° C.; and
c3) bisphenol A

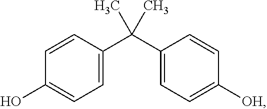 [SMILES: CC(C)(c1ccc(O)cc1)c1ccc(O)cc1]

melting point: 158° C.

### e) Co-Monomers

e1) The only representative co-monomer used, which at the same time served as a crosslinker for the cyanate ester monomer, was 3,4-epoxycyclohexylmethyl-3′,4′-epoxycyclohexane carboxylate (“epoxy”):

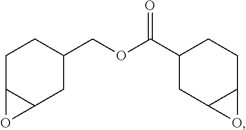 [SMILES: O=C(OCC1CCC2OC2C1)C1CCC2OC2C1]

liquid at room temperature (melting point: −37° C.).

### f) Oxidizing Agent

f1) The only representative oxidizing agent used in the polymerizable composition so far has been di-tert-butylperoxide (“DTBP”):

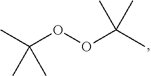

liquid at room temperature (melting point: −40° C.).

### Examples 1 to 8, Comparative Examples 1 and 2

### Characteristic d): 3D Printing

### Preparation of the Polymerizable Compositions

All compositions of the examples and comparative examples were produced in the same manner by simply mixing and heating all components to 80° C. or 90° C. in order to obtain a liquid mixture, and stirring the mixture until obtaining a homogeneous solution.

### Polymerization

The homogeneous solutions were either allowed to cool to room temperature, in which case they re-solidified (in the case of the inventive examples), and transferred to a heatable (or pre-heated) tray of a 3D printer, or quickly poured into a tray of a printer pre-heated to the respective irradiation temperature. The 3D printer used was in all cases a Caligma® 200UV by Cubicure, where one liquid layer having a defined layer thickness after the other was irradiated at the bottom side of a movable carrier platform and thus cured.

After reaching the irradiation temperature of 90° C. or 100° C. —and in some cases a simultaneous re-liquefaction of the solid bodies—the compositions were cured using “hot lithography” 3D printing by layer-wise irradiation using the laser scanning system of the printer with a wavelength of 375 nm. In each case, a layer thickness of 0.1 mm and a speed of the laser scanning system of 100 mm/s were selected, which resulted in solid three-dimensional parts having a predefined shape (measurements: 5×4×2 cm) for the inventive examples, while the two comparative examples did not show complete solidification, but provided only a shapeless, high-viscous mass.

Below, the type and amount of the components (in % by weight) as well as the respective temperature before and during irradiation are summarized for all examples and comparative examples.

### Example 1

| | | |
|---|---|---|
| cyanate ester: | a1) novolak cyanate | 94 |
| | Primaset ® PT-30 | |
| photoinitiator: | b1) [CpFeCumol]PF₆_{^{−}} | 1 |
| co-catalyst: | c1) nonylphenol | 5 |
| | | 100% by weight |

mixing temperature 90° C., irradiation temperature 100° C.

### Example 2

| | | |
|---|---|---|
| cyanate ester: | a1) novolak cyanate | 94 |
| | Primaset ® PT-30 | |
| photoinitiator: | b2) Me-CpMn(CO)₃ | 1 |
| co-catalyst: | c1) nonylphenol | 5 |
| | | 100% by weight |

mixing temperature 80° C., irradiation temperature 90° C.

### Example 3

| | | |
|---|---|---|
| cyanate ester: | a1) novolak cyanate | 94 |
| | Primaset ® PT-30 | |
| photoinitiator: | b3) Cp₂Ti(F₂Pyr)benzene | 1 |
| co-catalyst: | c1) nonylphenol | 5 |
| | | 100% by weight |

mixing temperature 100° C., irradiation temperature 120° C.

### Example 4

| | | |
|---|---|---|
| cyanate ester: | a1) novolak cyanate | 94 |
| | Primaset ® PT-30 | |
| photoinitiator: | b1) [CpFeCumol]PF₆_{^{−}} | 1 |
| co-catalyst: | c2) trimethylolpropane | 5 |
| | | 100% by weight |

mixing temperature 90° C., irradiation temperature 100° C.

### Example 5

| | | |
|---|---|---|
| cyanate ester: | a1) novolak cyanate | 84 |
| | Primaset ® PT-30 | |
| photoinitiator: | b1) [CpFeCumol]PF₆_{^{−}} | 1 |
| co-catalyst: | c3) bisphenol A | 5 |
| co-monomer: | e1) epoxy | 10 |
| | | 100% by weight |

mixing temperature 100° C., irradiation temperature 110° C.

### Example 6

| | | |
|---|---|---|
| cyanate ester: | a1) novolak cyanate | 94 |
| | Primaset ® PT-30 | |
| photoinitiator: | b1) [CpFeCumol]PF₆_{^{−}} | 1 |
| co-catalyst: | c3) bisphenol A | 5 |
| | | 100% by weight |

mixing temperature 100° C., irradiation temperature 110° C.

### Example 7

| | | |
|---|---|---|
| cyanate ester: | a2) bisphenol A dicyanate | 94 |
| photoinitiator: | b1) [CpFeCumol]PF₆_{^{−}} | 1 |
| co-catalyst: | c1) nonylphenol | 5 |
| | | 100% by weight |

mixing temperature 100° C., irradiation temperature 110° C.

### Example 8

| | | |
|---|---|---|
| cyanate ester: | a1) novolak cyanate | 47 |
| | Primaset ® PT-30 | |
| | a2) bisphenol A dicyanate | 47 |
| photoinitiator: | b1) [CpFeCumol]PF₆_{^{−}} | 1 |
| co-catalyst: | c1) nonylphenol | 5 |
| | | 100% by weight |

mixing temperature 90° C., irradiation temperature 100° C.

### Example 9

| | | |
|---|---|---|
| cyanate ester: | a1) novolak cyanate | 93 |
| | Primaset ® PT-30 | |
| photoinitiator: | b1) [CpFeCumol]PF₆_{^{−}} | 1 |
| co-catalyst: | c1) nonylphenol | 5 |
| oxidizing agent | f1) di-tert-butylperoxide | 1 |
| | | 100% by weight |

mixing temperature 90° C., irradiation temperature 100° C.

### Comparative Example 1

| | | |
|---|---|---|
| cyanate ester: | a1) novolak cyanate | 99 |
| | Primaset ® PT-30 | |
| photoinitiator: | b1) [CpFeCumol]PF₆_{^{−}} | 1 |
| co-catalyst: | — | 0 |
| | | 100% by weight |

mixing temperature 90° C., irradiation temperature 100° C.

### Comparative Example 2

| | | |
|---|---|---|
| cyanate ester: | a1) novolak cyanate | 95 |
| | Primaset ® PT-30 | |
| Photoinitiator: | — | 0 |
| Co- catalyst: | c1) nonylphenol | 5 |
| | | 100% by weight |

mixing temperature 80° C., irradiation temperature 100° C.

As mentioned above, the compositions of the two comparative examples did not result in solid bodies, but only in dimensionally unstable, highly viscous masses, while all nine examples of the present invention yielded the desired molded articles.

These were exposed to a dynamic mechanical thermal analysis (DMTA) regarding their thermomechanical properties, as well as tensile elongation tests, wherein all nine samples lead to excellent values, including glass transition temperatures (Tg) of more than 300° C. and tensile stresses (σ_{z}) far above 45 N/mm². Specifically, the following values (rounded mean values from three determinations) were measured for the molded articles obtained by 3D printing:

| Example | Tg [° C.] | σ_{z} [N/mm²] |
|---|---|---|
| Example 1 | 305 | 55 |
| Example 7 | 285 | 70 |

Values that high have not been achieved until now for molded articles produced by generative manufacturing processes using cyanate esters as monomers.

In addition, analogous experiments were used to produce the polymerizable compositions of the inventive Examples 1 and 9, which only differ in the presence of the oxidizing agent, as well as the Examples 7 and 8 by mixing under heating to 90° C., as described above. Afterwards, they were, however, not transferred to the tray of the 3D printer, but a sample of each was transferred into a DSC crucible. Then, they were introduced into the measurement chamber of a photo DSC device by Netzsch pre-heated to 100° C. and irradiated with wavelengths of 320-500 nm, where the maximum reaction enthalpy, ΔH, and the time to reach it, tₘₐₓ, were measured, resulting in the following values (rounded mean values from three determinations):

| Example | ΔH [J/g] | tₘₐₓ [s] |
|---|---|---|
| Example 1 | 260 ± 10 | 20 ± 2 |
| Example 7 | 430 ± 30 | 43 ± 5 |
| Example 8 | 390 ± 10 | 20 ± 3 |
| Example 9 | 290 ± 20 | 13 ± 3 |

Obviously, the presence of only 1% by weight of the oxidizing agent (instead of 1% by weight of a cyanate ester) in Example 9 allowed a reduction of the tₘₐₓ compared to the otherwise identical composition of Example 1 with the novolak cyanate a1) as photoinitiator by approximately one third. The same is also true for the comparison of Example 9 and Example 8 with a 50:50 mixture of novolak cyanate a1) and the bisphenol A dicyanate a2), and compared to Example 7, which only comprised the bisphenol A dicyanate a2), tₘₐₓ was reduced by as much as more than two thirds.

The inventive use of cyanate esters as monomers in a method for producing three-dimensional solid articles obviously offers clear and unexpected advantages compared to the state of the art.

1-10. (canceled)

11. A method of 3D printing a solid article from a polymerizable composition comprising cyanate ester monomers, at least one organometallic polymerization initiator, and a co-catalyst, wherein:
(a) the cyanate ester monomers comprise multifunctional cyanate esters having formula R(OCN)ₙ, wherein R is an n-valent carbohydrate residue having up to 50 carbon atoms and n is an integer ≥2;
(b) the organometallic polymerization initiator is an organometallic photoinitiator; and
(c) the co-catalyst comprises a compound comprising at least one acidic hydrogen atom;
the 3D printing method comprising:
(i) initially heating the composition to a heating temperature of >70° C. to obtain a homogeneous liquid mixture, and
(ii) irradiating the homogeneous mixture at at least the heating temperature with a wavelength suitable to activate the organometallic photoinitiator and to obtain a three-dimensional solid article.

12. The method according to claim 11, wherein the cyanate ester monomers comprise multifunctional aromatic cyanate esters.

13. The method according to claim 11, wherein the cyanate ester monomers comprise cyanates of bisphenol or novolak derivatives.

14. The method according to claim 11, wherein in the formula R(OCN)ₙ,
R comprises up to 40 carbon atoms; and/or
n=2 to 4.

15. The method according to claim 11, wherein the composition is initially heated to a temperature of 80° C. to 100° C. before step (ii); and/or the composition is heated to a temperature of 80° C. to 120° C. during step (ii).

16. The method according to claim 15, wherein the composition is initially heated to a temperature of 80° C. to 90° C. before step (ii); and/or the composition is heated to a temperature of 90° C. to 100° C. during step (ii).

17. The method according to claim 11, wherein the organometallic photoinitiator comprises an organometallic complex of an Al, Fe, Mn, Ru, Zn, Co or Cu ion.

18. The method according to claim 17, wherein the organometallic photoinitiator comprises an organometallic complex of an Fe ion.

19. The method according to claim 17, wherein the organometallic complex is a sandwich or semi-sandwich compound.

20. The method according to claim 19, wherein the organometallic complex is a sandwich compound or semi-sandwich carbonyl complex.

21. The method according to claim 11, wherein the co-catalyst comprises a phenol derivative.

22. The method according to claim 21, wherein the co-catalyst comprises nonylphenol or bisphenol A.

23. The method according to claim 11, wherein the polymerizable composition further comprises an oxidizing agent.

24. The method according to claim 23, wherein the polymerizable composition further comprises an organic oxidizing agent.

25. The method according to claim 24, wherein the organic oxidizing agent comprises di-tert-butyl peroxide.

26. The method according to claim 11, further comprising thermal post-curing after step (ii).

27. The method according to claim 26, wherein the thermal post-curing is conducted by
heating to a temperature >200° C. for several hours and/or
heating to a temperature <200° C. for several days.
